(19) United States
(12) Patent Application Publication
(10) Pub. No.: US 2023/0257525 A1
(43) Pub. Date: Aug. 17, 2023

(54) Polyimide Precursor Composition and Polyimide Film Produced Using the Same

(71) Applicant: SK Innovation Co., Ltd., Seoul (KR)

(72) Inventors: Cheol Min Yun, Daejeon (KR); Chun Ho Kim, Daejeon (KR); Hye Jin Park, Daejeon (KR); Chang Q Lee, Daejeon (KR)

(21) Appl. No.: 18/108,875

(22) Filed: Feb. 13, 2023

(30) Foreign Application Priority Data
Feb. 14, 2022 (KR) 10-2022-0018641
Feb. 14, 2022 (KR) 10-2022-0018678

(51) Int. Cl. C08G 73/10; C08J 5/18; C09D 179/08; C09D 7/20

(52) U.S. Cl. CPC C08G 73/106; C08G 73/1032; C08G 73/1042; C08G 73/1082; C08J 5/18; C09D 179/08; C09D 7/20; C08J 2379/08

(57) ABSTRACT

Provided is a polyimide precursor composition including a polyimide precursor including a siloxane structure and a solvent having a negative partition coefficient (log P). The polyimide precursor composition may be used to alleviate thermal expansion-contraction behavior, thereby producing a polyimide film with minimal curling.

### CROSS-REFERENCE TO RELATED APPLICATIONS

This application claims priority to Korean Patent Application No. 10-2022-0018641, filed Feb. 14, 2022, and Korean Patent Application No. 10-2022-0018678, filed Feb. 14, 2022, the disclosures of each of which are hereby incorporated by reference in their entireties.

### BACKGROUND OF THE INVENTION

### Field of the Invention

The following disclosure relates to a polyimide precursor composition, a method of preparing the same, and a polyimide film and a flexible cover window produced using the same.

### Description of Related Art

A polyimide film is a material for a substrate, a cover window, and the like of a display device, and is attracting attention as a next-generation material which may replace tempered glass. In order to apply a film to a display device, it is essential to improve intrinsic yellow index characteristics and impart colorless and transparent characteristics, and furthermore, in order to make the film applicable to a foldable or flexible display device, mechanical properties should be also improved, and thus, the required performance of the polyimide film for a display device is being gradually increased.

In particular, it is important that a flexible display device which may be bent or folded when the user wants is designed as a flexible structure so that the device is not easily broken upon external impact or during a bending or folding process.

### SUMMARY OF THE INVENTION

An embodiment of the present disclosure is directed to providing a polyimide precursor composition which may produce a polyimide film capable of alleviating thermal expansion-extraction behavior.

Another embodiment of the present disclosure is directed to providing a method of preparing the polyimide precursor composition.

Another embodiment of the present disclosure is directed to providing a polyimide film comprising a cured product of the polyimide precursor composition and a flexible cover window comprising the film.

Another embodiment of the present disclosure is directed to providing a composition for coating ultra-thin tempered glass comprising the polyimide precursor composition.

Still another embodiment of the present disclosure is directed to providing an ultra-thin tempered glass multilayer structure in which one or both surfaces of the ultra-thin tempered glass are coated with the composition for coating ultra-thin tempered glass.

In one general aspect, a polyimide precursor composition comprises: a polyimide precursor comprising a unit derived from an acid anhydride or a diamine comprising a structure of the following Chemical Formula 1, and

a solvent having a negative partition coefficient (log P):

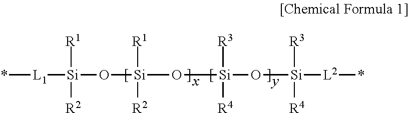

wherein

R¹ and R² are independently of each other C₁₋₅ alkyl which is unsubstituted or substituted with one or more halogens;

R³ and R⁴ are independently of each other C₄₋₁₀ aryl which is unsubstituted or substituted with one or more halogens;

L¹ and L² are independently of each other C₁₋₁₀ alkylene; and

x and y are independently of each other an integer of 1 or more.

In another general aspect, a method of preparing a polyimide precursor composition comprises: reacting an acid anhydride or a diamine comprising the structure represented by Chemical Formula 1 with a solvent comprising a solvent having a negative partition coefficient.

In another general aspect, a polyimide film comprises a cured product of the polyimide precursor composition.

In another general aspect, a flexible cover window comprises the polyimide film.

In another general aspect, a composition for coating an ultra-thin tempered glass comprises the polyimide precursor composition.

In another general aspect, an ultra-thin tempered glass multilayer structure in which one or both surfaces of the ultra-thin tempered glass are coated with the composition for coating ultra-thin tempered glass is provided.

In still another general aspect, an ultra-thin tempered glass multilayer structure comprises the polyimide film on one or both surfaces of the ultra-thin tempered glass.

Other features and aspects will be apparent from the following detailed description, the drawings, and the claims.

### DESCRIPTION OF THE INVENTION

Hereinafter, the embodiment of the present disclosure will be described in detail so as to be easily practiced by those with ordinary skill in the art to which the present disclosure pertains.

However, the present disclosure may be implemented in various different forms and is not limited to the implementations described herein. In addition, it is not intended to limit the protection scope defined in the claims.

In addition, the technical and scientific terms used in the description of the present disclosure may have, unless otherwise defined, the meaning commonly understood by those with ordinary skill in the art.

As used herein, the singular form of “a”, “an”, and “the” include plural referents unless the context clearly states otherwise.

For the purposes of this specification, unless otherwise indicated, all numbers expressing quantities of ingredients, reaction conditions, dimensions, physical characteristics, and so forth used in the specification and claims are to be understood as being modified in all instances by the term “about.” Unless indicated to the contrary, the numerical parameters set forth in the following specification and attached claims are approximations that can vary depending upon the desired properties sought to be obtained by the present invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Also, it should be understood that any numerical range recited herein is intended to include all sub-ranges subsumed therein. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g., 1 to 6.3, or 5.5 to 10, or 2.7 to 6.1.

Throughout the specification of the present disclosure, unless explicitly described to the contrary, “comprising” or “including” any constituent elements will be understood to imply further inclusion of other constituent elements rather than the exclusion of any other constituent elements.

Hereinafter, unless otherwise particularly defined in the present specification, a “combination thereof” refers to a mixture or copolymerization of constituents.

Hereinafter, unless otherwise particularly defined in the present specification, the term “A and/or B” in the present specification may refer to an embodiment including both A and B or an embodiment selecting one of A and B.

Hereinafter, unless otherwise particularly defined in the present specification, a “polymer” may comprise an oligomer a homopolymer or a copolymer. The copolymer may comprise one or more random copolymer(s), block copolymer(s), graft copolymer(s), alternating copolymer(s), gradient copolymer(s), combinations thereof or all of them.

Hereinafter, unless otherwise particularly defined in the present specification, a “polyamic acid” refers to a polymer comprising a structural unit comprising an amic acid moiety, and a “polyimide” may refer to a polymer comprising a structural unit comprising an imide moiety.

Hereinafter, unless otherwise particularly defined in the present specification, a polyimide film may be a film comprising a polyimide, or may be a high thermal resistant film produced by solution polymerizing an acid anhydride compound in a diamine compound solution to prepare a polyamic acid, and performing imidization.

Hereinafter, unless otherwise defined in the present specification, it will be understood that when an element such as a layer, a film, a thin film, a region, or a substrate is referred to as being “on” or “above” another element, it may be “directly on” the other element, or intervening element(s) may also be present therebetween.

Hereinafter, unless otherwise particularly defined in the present specification, “substituted” refers to a hydrogen atom in a compound being substituted with a substituent, and for example, the substituent may be selected from deuterium, halogen atoms (F, Br, Cl, or I), a hydroxyl group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid or a salt thereof, a C₁₋₃₀ alkyl group, a C₂₋₃₀ alkenyl group, a C₂₋₃₀ alkynyl group, a C₆₋₃₀ aryl group, a C₇₋₃₀ arylalkyl group, a C₁₋₃₀ alkoxy group, a C₁₋₂₀ heteroalkyl group, a C₃₋₂₀ heteroarylalkyl group, a C₃₋₃₀ cycloalkyl group, a C₃₋₁₅ cycloalkenyl group, a C₆₋₁₅ cycloalkynyl group, a C₂₋₃₀ heterocyclic group, or a combination thereof.

A partition coefficient (P) describes the propensity of a neutral (uncharged) compound to dissolve in an immiscible biphasic system of lipid (fats, oils, organic solvents) and water.

A negative partition coefficient has a negative value for log P, and means that the compound has a higher affinity for the aqueous phase (it is more hydrophilic).

A positive partition coefficient has a positive value for log P, and means that the compound has a higher affinity for the lipid phase (it is more lipophilic).

An ultra-thin tempered glass (ultra thin glass, UTG) is a tempered glass material component used in a display cover window, and a method of coating a polyimide film for scattering resistant coating on UTG is known, but a problem of film curling in a drying step due to a difference in a thermal expansion coefficient between UTG and a polyimide film was not solved. In one embodiment of the present invention, a stress relaxation segment is introduced into a polyimide precursor molecule, thereby providing a polyimide precursor which may minimize curling when coated on UTG and a composition comprising the same.

One embodiment provides a polyimide precursor composition comprising: a polyimide precursor comprising a unit derived from an acid anhydride and/or a diamine comprising a structure of the following Chemical Formula 1; and

a solvent having a negative partition coefficient (log P).

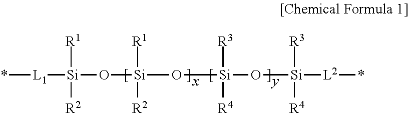

wherein

R¹ and R² are independently of each other C₁₋₅ alkyl which is unsubstituted or substituted with one or more halogens;

R³ and R⁴ are independently of each other C₄₋₁₀ aryl which is unsubstituted or substituted with one or more halogens;

L¹ and L² are independently of each other C₁₋₁₀ alkylene; and x and y are independently of each other an integer of 1 or more.

In one embodiment, R¹ and R² may be independently of each other C₁₋₃ alkyl which is unsubstituted or substituted with one or more halogens, C₁₋₂ alkyl which is unsubstituted or substituted with one or more halogens, or methyl which is unsubstituted or substituted with one or more halogens. R³ and R⁴ may be independently of each other C₄₋₈ aryl which is unsubstituted or substituted with one or more halogens, C₄₋₆ aryl which is unsubstituted or substituted with one or more halogens, or phenyl which is unsubstituted or substituted with one or more halogens. L¹ and L² may be independently of each other C₁₋₅ alkylene, C₂₋₅ alkylene, or propylene. The alkyl or the aryl substituted with one or more halogens may be substituted with one or more halogens selected from I, Br, Cl, and/or F.

In one embodiment, x and y may be independently of each other 1 to 50, 1 to 30, or 1 to 20, but is not limited thereto. In addition, for example, when the sum of x and y is 100, x may be 1 to 99 and y may be 99 to 1, or x may be 10 to 90 and y may be 90 to 10.

In one embodiment, the acid anhydride and/or the diamine comprising the structure of Chemical Formula 1 may be an acid anhydride and/or a diamine comprising a dimethylsiloxane-diphenylsiloxane (DMS-DPS) structure of the following Chemical Formula 2:

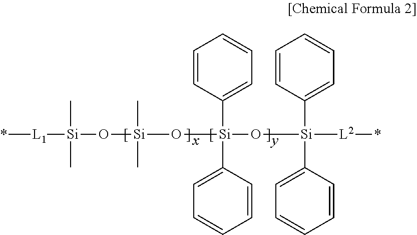

In one embodiment, the unit comprising the structure of Chemical Formula 1 may be derived from a diamine. An example of the diamine comprising the structure of Chemical Formula 1 includes X-22-1660B-3 available from Shin-etsu having the following structure:

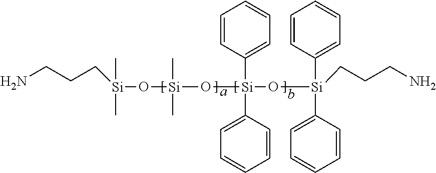

wherein a and b are independently of each other an integer of 1 or more, 1 to 50, 1 to 30, or 1 to 20, but is not necessarily limited thereto. In some examples, when the sum of a and b is 100, a may be 1 to 99 and b may be 99 to 1, or a may be 10 to 90 and b may be 90 to 10.

The polyimide precursor composition according to one embodiment comprises the unit derived from the acid anhydride and/or the diamine comprising the structure of Chemical Formula 1, thereby minimizing a curling phenomenon due to a difference in thermal properties between different types of layers, when an ultra-thin tempered glass is coated with the composition.

In one embodiment, the unit derived from the acid anhydride and/or the diamine comprising the structure of Chemical Formula 1 may be included at 20 wt % or more, 25 wt % or more, 30 wt % or more, 40 wt % or more, 30 wt % to 70 wt %, 30 wt % to 60 wt %, 30 wt % to 55 wt %, 30 wt % to 50 wt %, 35 wt % to 60 wt %, 35 wt % to 55 wt %, 35 wt % to 50 wt %, 40 wt % to 60 wt %, 40 wt % to 55 wt %, or 40 wt % to 50 wt %, with respect to the total weight of the polyimide precursor (for example, the total weight of the diamine and acid anhydride monomers), but is not necessarily limited thereto.

In one embodiment, the unit derived from the acid anhydride and/or the diamine comprising the structure of Chemical Formula 1 may be included at 30 wt % or more with respect to the total weight of the unit derived from the diamine included in the polyimide precursor composition. Otherwise, for example, the unit may be included at 40 wt % or more, 50 wt % or more, 60 wt % or more, 40 wt % to 90 wt %, or 50 wt % to 80 wt %, but is not necessarily limited thereto.

In one embodiment, the acid anhydride and/or the diamine comprising the structure of Chemical Formula 1 may have a molecular weight of 3000 g/mol or more, 3500 g/mol or more, 4000 g/mol or more, 3000 g/mol to 5500 g/mol, 3500 g/mol to 5000 g/mol, or 4000 g/mol to 5500 g/mol, but is not necessarily limited thereto.

In one embodiment, the solvent having negative log P may comprise not only a solvent comprising only the solvent having negative log P, but also, when both a solvent having negative log P and a solvent having positive log P are included, a solvent having a negative total log P value of a mixed solvent.

The polyimide precursor composition according to one embodiment comprises the acid anhydride and/or the diamine comprising the structure of Chemical Formula 1, and the solvent having negative log P, thereby implementing excellent optical properties, for example, a low haze, while minimizing a curling phenomenon when an ultra-thin tempered glass is coated with the composition.

As an example, the solvent having negative log P may comprise one or more solvents of methylether (PGME), dimethylformamide (DMF), dimethylacetamide (DMAc), N,N-dimethylpropaneamide (DMPA), N-ethylpyrrolidone (NEP), and/or methylpyrrolidone (NMP), and may further comprise one or more solvents selected from N,N-diethylpropaneamide (DEPA), N,N-diethylacetamide (DEAc), cyclohexanone (CHN), and/or N,N-diethylformamide (DEF).

The polyimide precursor composition according to one embodiment may further comprise one or more solvent(s) having positive log P. The solvent having positive log P may be one or more selected from cyclohexanone (CHN), N,N-diethylpropaneamide (DEPA), N,N-diethylacetamide (DEAc), and/or N,N-diethylformamide (DEF), but is not necessarily limited thereto.

The log P may be calculated with ACD/log P module of ACD/Percepta platform available from ACD/Labs, and the ACD/log P module may be measured with algorithm based on quantitative structure-property relationship (QSPR) methodology using a 2D structure of a molecule. The results of measuring the log P value of the solvent with three models (Classic, GALAS, Consensus) of the program from ACD/Labs are shown in the following Table 1:

TABLE 1

| | Classic | GALAS | Consensus |
|---|---|---|---|
| DMF | −1.01 | −0.70 | −0.78 |
| DMAc | −0.75 | −0.25 | −0.37 |
| DMPA | −0.21 | −0.05 | −0.10 |
| NMP | −0.40 | −0.33 | −0.34 |
| PGME | −0.45 | −0.14 | −0.22 |
| NEP | 0.13 | −0.10 | −0.05 |
| CHN | 0.76 | 0.95 | 0.90 |

In one embodiment, the solvent having negative log P may have a log P value of, for example, −2.00 to −0.01, −1.50 to −0.01, or −1.00 to −0.05, as measured in accordance with the measurement method of log P from ACD/Labs, but is not necessarily limited thereto. In addition, the solvent having positive log P may have a log P value of, for example, 0.01 to 2.00, 0.01 to 1.5, 0.05 to 1.0, or 0.1 to 1.0, as measured in accordance with the measurement method of log P from ACD/Labs, but is not necessarily limited thereto.

In one embodiment, the solvent comprised in the polyimide precursor composition may be a mixed solvent of the solvent(s) having negative log P and the solvent(s) having positive log P. Here, the mixed solvent may have a negative log P as calculated in accordance with the measurement method of log P from ACD/Labs. For example, in the case of a mixed solvent of PGME and CHN adopted in one embodiment, the log P value may be shown as in the following Table 2 according to the composition ratio (weight ratio).

TABLE 2

| Composition (weight ratio) | log P |
|---|---|
| PGME/CHN (10:0) | −0.45 |
| PGME/CHN (9:1) | −0.33 |
| PGME/CHN (8:2) | −0.23 |
| PGME/CHN (7:3) | −0.13 |
| PGME/CHN (6:4) | −0.02 |
| PGME/CHN (5:5) | 0.08 |
| PGME/CHN (4:6) | 0.18 |
| PGME/CHN (3:7) | 0.30 |
| PGME/CHN (2:8) | 0.42 |
| PGME/CHN (1:9) | 0.57 |
| PGME/CHN (0:10) | 0.76 |

In one embodiment, when the solvent included in the polyimide precursor composition is a mixed solvent of the solvent having negative log P and the solvent having positive log P, a mass ratio between the solvent having negative log P and the solvent having positive log P may be 5:5 to 9.5:0.5. Otherwise, the mass ratio may be 5:5 to 9:1, 6:4 to 9:1, 6.5:3.5 to 9:1, 7:3 to 9:1, or 7.5:2.5 to 8.5:1.5, but is not necessarily limited thereto.

In one embodiment, the solvent comprised in the polyimide precursor composition may comprise at least one, specifically one or more, two or more, three or more, or 1 to 3 hydroxyl groups (—OH) in the molecule. Otherwise, the solvent may be a solvent comprising any one or more of an ether group (—O—) and an oxo group (═O).

When the polyimide precursor composition according to one embodiment comprises both the solvent(s) having negative log P and the solvent(s) having positive log P, the uniformity of the composition (solution) may be significantly increased to improve cloudiness and phase separation, thereby producing a colorless and transparent polyimide film. In addition, when a substrate is coated with a polyimide film by using both the solvent(s) having negative log P and the solvent(s) having positive log P, a curling phenomenon due to a difference in thermal properties between different types of layers may be minimized.

In one embodiment, the polyimide precursor composition may comprise a unit derived from a diamine commonly used in the art. For example, the unit derived from a diamine may comprise a unit derived from an aromatic diamine, the aromatic diamine may be a dianhydride comprising at least one aromatic ring, and the aromatic ring may be a single ring, a fused ring of two or more aromatic rings, or a non-fused ring in which two or more aromatic rings are linked by a single bond, a substituted or unsubstituted C₁₋₁₀ alkylene group, O, or C(═O). For example, the unit derived from a diamine may comprise a unit derived from one or more aromatic diamines selected from the group consisting of 2,2′-bis(trifluoromethyl)-benzidine (TFMB), 2,2′-bis[4-(4-aminophenoxy)phenyl]hexafluoropropane (4BDAF), 2,2-bis(3-amino-4-hydroxyphenyl)-hexafluoropropane (6FAP), 4,4′-oxydianiline (ODA), p-phenylenediamine (pPDA), m-phenylenediamine (mPDA), p-methylenedianiline (pMDA), m-methylenedianiline (mMDA), 1,3-bis(3-aminophenoxy)benzene (133APB), 1,3-bis(4-aminophenoxy)benzene (134APB), 1,4-bis(4-aminophenoxy)benzene (144APB), bis(4-aminophenyl)sulfone (4,4′-DDS), bis(3-aminophenyl)sulfone (3DDS), 2,2-bis[4-(4-aminophenoxy)phenyl]propane (6HMDA), and derivatives thereof, but is not limited thereto.

In one embodiment, the polyimide precursor composition may comprise a unit derived from an acid anhydride commonly used in the art. For example, the acid anhydride may be an acid anhydride comprising an aromatic ring, an acid anhydride comprising an aliphatic ring, a tetracarboxylic acid dianhydride, or a combination thereof. In one embodiment, the acid anhydride may be one or more acid anhydrides selected from the group consisting of ethylene glycol bis(4-trimellitic anhydride) (TMEG), 4,4′-oxydiphthalic anhydride (ODPA), 2,2-bis[4-(2,3-dicarboxyphenoxy)phenyl]propane dianhydride, 4,4′-(3,4-dicarboxyphenoxy)diphenylsulfide dianhydride, pyromellitic dianhydride (PMDA), 3,3′,4,4′-biphenyltetracarboxylicdianhydride (BPDA), 3,3′,4,4′-benzophenonetetracarboxylicdianhydride (BTDA), 4,4′-(4,4′-isopropylbiphenoxy)biphthalic anhydride (BPADA), 3,3′,4,4′-diphenylsulfonetetracarboxylic dianhydride (DSDA), 2,2-bis-(3,4-dicarboxylphenyl) hexafluoropropane dianhydride (6FDA), p-phenylenebistrimellitic monoester anhydride (TMHQ), 2,2-bis(4-hydroxyphenyl)propanedibenzoate-3,3′,4,4′-tetracarboxylic dianhydride (ESDA), naphthalenetetracarboxylic dianhydride (NTDA), and derivatives thereof.

For example, the acid anhydride may be a compound represented by the following Chemical Formula 3 or 4:

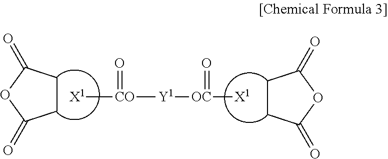

wherein

X¹ is independently of each other a C₃₋₁₀ aliphatic ring or a C₄₋₁₀ aromatic ring, and Y¹ is a linker including a single bond, a substituted or unsubstituted C₁₋₂₀ aliphatic chain, a substituted or unsubstituted C₃₋₁₀ aliphatic ring and/or a substituted or unsubstituted C₄₋₁₀ aromatic ring. Specifically, Y¹ may include two or more C₄₋₁₀ arylene linked by C₁₋₂₀ alkylene, C₁₋₁₀ alkylene, C₁₋₅ alkylene, C₃₋₁₀ cycloalkylene, C₄₋₁₀ arylene, two or more C₃₋₁₀ cycloalkylenes linked by C₁₋₂₀ alkylene, or two or more C₄₋₁₀ arylene linked by C₁₋₂₀ alkylene.

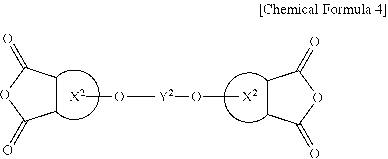

wherein

X² is independently of each other a C₃₋₁₀ aliphatic ring or a C₄₋₁₀ aromatic ring, and Y² is a linker including a single bond, a substituted or unsubstituted C₂₋₂₀ aliphatic chain, a substituted or unsubstituted C₃₋₁₀ aliphatic ring and/or a substituted or unsubstituted C₄₋₁₀ aromatic ring. Specifically, Y² may include two or more C₄₋₁₀ arylene linked by C₁₋₂₀ alkylene, C₁₋₁₀ alkylene, C₁₋₅ alkylene, C₃₋₁₀ cycloalkylene, C₄₋₁₀ arylene, two or more C₃₋₁₀ cycloalkylenes linked by C₁₋₂₀ alkylene, or two or more C₄₋₁₀ arylene linked by C₁₋₂₀ alkylene.

Specifically, the acid anhydride may be any one or more of the compounds of the group represented by the following chemical formulae:

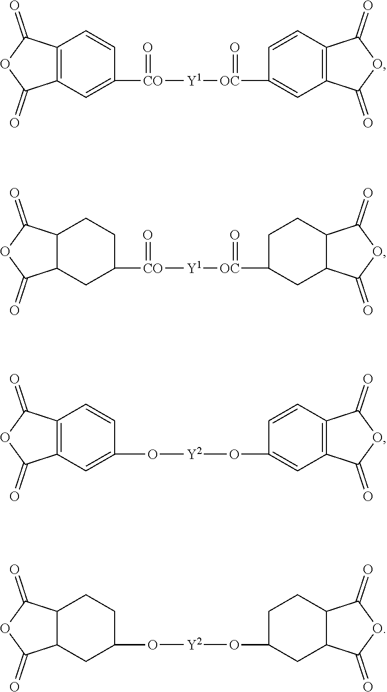

In one embodiment, a solid content of the polyimide precursor composition may be 40 wt % or less, 10 wt % to 40 wt %, 35 wt % or less, 30 wt % or less, or 20 wt % to 40 wt %, based on the total weight of the polyimide precursor composition. Here, the solid content may be a polyamic acid and/or a polyimide.

In one embodiment, the polyimide precursor and/or the polyimide may have a molecular weight of 500 g/mol to 200,000 g/mol or 10,000 g/mol to 100,000 g/mol, and is not necessarily limited thereto.

In one embodiment, the polyimide precursor composition may further comprise an additive commonly used in the art, and for example, may further comprise a flame retardant, an adhesive strength improver, an antioxidant, a UV protector, and/or a plasticizer.

Hereinafter, the method of preparing a polyimide precursor composition according to one embodiment will be described.

The method of preparing a polyimide precursor composition according to one embodiment may comprise: reacting a monomer comprising an acid anhydride and/or a diamine comprising a structure of the following Chemical Formula 1 with a solvent comprising a solvent(s) having a negative partition coefficient (log P).

Here, the acid anhydride and/or the diamine comprising the structure of Chemical Formula 1 may be used at 20 wt % or more with respect to the total weight of the polyimide precursor (for example, the total weight of the diamine and acid anhydride monomer).

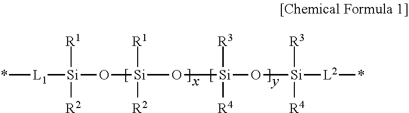

wherein

R¹ and R² are independently of each other C₁₋₅ alkyl which is unsubstituted or substituted with one or more halogens;

R³ and R⁴ are independently of each other C₄₋₁₀ aryl which is unsubstituted or substituted with one or more halogens;

L¹ and L² are independently of each other C₁₋₁₀ alkylene; and

x and y are independently of each other an integer of 1 or more.

For R¹, R², R³, R⁴, L¹, L², x, and y above, the above description for the polyimide precursor composition may be applied the same.

In one embodiment, the method of preparing a polyimide precursor composition may further comprise adding the acid anhydride to prepare a polyamic acid, after dissolution in the solvent(s).

In one embodiment, the solvent(s) may be a mixed solvent which further comprises a solvent having positive log P.

In one embodiment, the method of preparing a polyimide precursor composition may be performed by two reaction conditions. For example, the method of preparing a polyimide precursor composition according to one embodiment may comprise reacting a monomer comprising an acid anhydride and/or a diamine comprising the structure represented by Chemical Formula 1 in the presence of a mixed solvent of a solvent(s) having a negative partition coefficient and a solvent(s) having a positive partition coefficient to prepare a polyamic acid solution (1 step).

Alternatively, the method of preparing a polyimide precursor composition according to one embodiment may comprise reacting a monomer comprising an acid anhydride and/or a diamine comprising the structure represented by Chemical formula 1 in the presence of a solvent(s) having a negative partition coefficient to prepare a polyamic acid solution; and adding a solvent(s) having a positive partition coefficient (for example, a dilution) (two steps).

Therefore, the solvent(s) having a negative partition coefficient and the solvent(s) having a positive partition coefficient may be employed as a mixed solvent; or the reaction is first performed in the presence of the solvent(s) having a negative partition coefficient and then the solvent(s) having a positive partition coefficient may be used as a dilution solvent, or the reaction is first performed in the presence of the solvent(s) having a positive partition coefficient and then the solvent(s) having a negative partition coefficient may be used as a dilution solvent.

In one embodiment, the method of preparing a polyimide precursor composition may comprise dissolving a diamine monomer in the presence of a solvent(s); and adding an acid anhydride to prepare a polyamic acid solution.

For the method of preparing a polyimide precursor composition, the above description for the polyimide precursor composition may be applied the same.

One embodiment provides a polyimide film comprising a cured product of the polyimide precursor composition according to one embodiment.

The polyimide film according to one embodiment comprises the unit represented by Chemical Formula 1, thereby having an effect of minimizing a curling phenomenon due to a difference in thermal characteristics between different types of films.

The polyimide film according to one embodiment is produced from a polyimide precursor composition comprising a polyimide precursor comprising the unit represented by Chemical Formula 1 and a solvent comprising a solvent(s) having negative log P; or a polyimide precursor composition comprising a polyimide precursor comprising the unit represented by Chemical Formula 1 and both a solvent(s) having negative log P and a solvent(s) having positive log P, whereby the film is colorless and transparent and has an effect of minimizing a curling phenomenon due to a difference in thermal characteristics between different types of films.

The polyimide film according to one embodiment may be a film in which the unit derived from the acid anhydride or the diamine comprising the structure of Chemical Formula 1 is included, a temperature at which a weight is decreased by 1% as compared with an initial weight is 390° C. in in thermal gravimetric analysis (TGA), and a haze measured in accordance with the ASTM D1003 standard is 0.2% or less.

The polyimide film according to one embodiment may have a haze value of 0.2% or less, 0.18% or less, 0.15% or less, 0.12% or less, 0.05% to 0.15%, 0.08% to 0.15%, or 0.1% to 0.15%, as measured in accordance with the ASTM D1003 standard, but is not necessarily limited thereto.

The polyimide film according to one embodiment may have, as a result of thermal gravimetric analysis (TGA), a temperature at which a weight is decreased by 1% as compared with an initial weight of 390° C. or lower, 380° C. or lower, 370° C. or lower, 360° C. or lower, 330° C. to 390° C., 330° C. to 380° C., 330° C. to 370° C., 340° C. to 390° C., 340° C. to 380° C., 340° C. to 370° C., 350° C. to 370° C., 330° C. to 360° C., 340° C. to 360° C., or 350° C. to 360° C.

The polyimide film according to one embodiment may have, as a result of thermal gravimetric analysis (TGA), a weight reduction rate at 600° C. of 60% or more, 65% or more, 68% or more, 70% or more, 72% or more, 60% to 85%, 65% to 85%, 60% to 80%, 65% to 80%, 65% to 75%, 68% to 85%, 68% to 82%, 68% to 80%, 68% to 79%, 70% to 85%, 70% to 82%, 70% to 80%, 70% to 79%, 72% to 85%, 72% to 82%, 72% to 80%, or 72% to 79%.

In one embodiment, the polyimide film may be produced by imidizing the polyimide precursor composition according to one embodiment. The imidization may be performed by a chemical imidization or thermal imidization method. For example, the imidization may be performed by a chemical reaction comprising adding a dehydrating agent and/or an imidization catalyst to the polyimide precursor composition and then heating, or imidization while refluxing the solution.

In the chemical imidization method, as the imidization catalyst, pyridine, triethylamine, picoline, quinoline, or the like may be used, and also, substituted or unsubstituted nitrogen-containing heterocyclic compounds, N-oxide compounds of nitrogen-containing heterocyclic compounds, substituted or unsubstituted amino acid compounds, aromatic hydrocarbon compounds having a hydroxyl group, or aromatic heterocyclic compounds may be used, and in particular, lower alkylimidazole such as 1,2-dimethylimidazole, N-methylimidazole, N-benzyl-2-methylimidazole, 2-methylimidazole, 2-ethyl-4-methylimidazole, and 5-methylbenzimidazole, imidazole derivatives such as N-benzyl-2-methylimidazole, substituted pyridine such as isoquinoline, 3,5-dimethylpyridine, 3,4-dimethylpyridine, 2,5-dimethylpyridine, 2,4-dimethylpyridine, and 4-n-propylpyridine, p-toluenesulfonic acid, or the like may be used.

Alternatively, the imidization may be performed by a method comprising applying the polyimide precursor composition on a substrate and then performing a heat treatment. The polyimide precursor composition may be in the form of a solution dissolved in an organic solvent, and when the composition has the form, for example, when the polyimide precursor is synthesized in an organic solvent, the solution may be a reaction solution to be obtained itself, or the reaction solution diluted with other solvents. In addition, when the polyimide precursor is obtained as a solid powder, this may be dissolved in an organic solvent to form a solution.

In one embodiment, the polyimide film may be produced by a method comprising applying the polyimide precursor composition according to one embodiment on a substrate, and performing a heat treatment. Here, the heat treatment may comprise a step of drying at 50° C. to 200° C., 50° C. to 150° C., or 60° C. to 100° C. for 5 minutes to 60 minutes or 5 minutes to 30 minutes, and then a heat treatment at 150° C. to 300° C., 180° C. to 250° C., or 200° C. to 250° C. for 10 minutes to 60 minutes or 20 minutes to 40 minutes.

In one embodiment, the polyimide film may have a thickness of 1 μm to 100 μm, 1 μm to 50 μm, or 1 μm to 30 μm, but is not necessarily limited thereto.

One embodiment provides a flexible cover window comprising the polyimide film and/or a flexible display device comprising the same. In one embodiment, the cover window may be used as an outermost substrate of the flexible display device, and an example of the flexible display device may comprise various image display devices such as a common liquid crystal display device, an electroluminescent display device, a plasma display device, and a field emission display device.

One embodiment provides a composition for coating a glass substrate comprising the polyimide precursor composition, and an example of the glass substrate may comprise an ultra-thin tempered glass (ultra thin glass, UTG).

One embodiment provides an ultra-thin tempered glass multilayer structure in which one or both surfaces of the ultra-thin tempered glass are coated with the composition for coating ultra-thin tempered glass. The polyimide precursor composition according to one embodiment has minimal curling even when coated on the ultra-thin tempered glass, may be usefully applied to a display device and the like comprising the ultra-thin tempered glass multilayer structure.

One embodiment provides an ultra-thin tempered glass multilayer structure comprising the polyimide film according to one embodiment on one or both surfaces according to the ultra-thin tempered glass.

In one embodiment, when a curling amount is calculated by measuring a height from the ground using a ruler at both ends of the multilayer structure coated with the polyimide film or the ultra-thin tempered glass multilayer structure coated with the polyimide film according to one embodiment (or when the average of the measured values at both sides is calculated), the value may be 4.0 mm or less, 3.5 mm or less, 3.0 mm or less, 2.5 mm or less, or 0.1 mm to 4.0 mm, 0.1 mm to 3.5 mm, 0.1 mm to 3.0 mm, 0.1 mm to 2.5 mm, 0.1 mm to 2.0 mm, 0.1 to 1.5 mm, 0.1 to 1.0 mm, 0.1 mm to 0.9 mm, 0.1 to 0.8 mm, 0.1 to 0.6 mm, 0.1 mm to 0.5 mm, or 0.2 mm to 1.0 mm, but is not necessarily limited thereto.

Hereinafter, the examples and the experimental examples of the present disclosure will be described in detail. However, the examples and the experimental examples described later are only illustrative of a part of the present disclosure, and the present disclosure is not limited thereto.

### Example 1

An agitator with a nitrogen airflow flowing was filled with 248 g of a solvent in which N,N-dimethylpropanamide (DMPA) and propylene glycol methyl ether (PGME) were mixed at a mass ratio of 8:2. In a state of maintaining the temperature of the reactor at 25° C., 24.5 g of 2,2′-bis(trifluoromethyl)benzidine (TFMB) and 40.7 g (about 40 wt % based on the total monomer mass) of a dimethylsiloxane-diphenylsiloxane (DMS-DPS) oligomer diamine compound (Shin-etsu, X-22-1660B-3, molecular weight: 4,400 g/mol) were added thereto and dissolved. 36 g of ethylene glycol bis(4-trimellitic anhydride (TMEG-100) was added thereto and stirring was performed while it was dissolved at 50° C. for 8 hours and at room temperature for 24 hours, thereby preparing a polyamic acid resin. At this time, each monomer had a mole ratio of TFMB/X-22-1660B-3:TMEG-100=0.99:1.0. A solvent in which DMPA/PGME was mixed at a mass ratio of 8:2 was further added to adjust the solid content to 25 wt %, thereby preparing the polyimide precursor composition of Example 1.

Next, the polyimide precursor composition was applied on an ultra-thin tempered glass (UTG, thickness: 30 μm) with a meyer bar, dried at 80° C. for 10 minutes under a nitrogen airflow, heated at 230° C. for 15 minutes, and cured to produce a UTG multilayer structure coated with the polyimide film (thickness: 10 μm).

### Example 2

A polyimide precursor composition having a solid content of 25 wt % was prepared in the same manner as in Example 1, except that 45 wt % of the DMS-DPS oligomer diamine compound (Shin-etsu, X-22-1660B-3) was used based on the total monomer mass, and then a UTG multilayer structure coated with the polyimide film (thickness: 10 μm) was produced in the same manner as in Example 1.

### Example 3

A polyimide precursor composition having a solid content of 25 wt % was prepared in the same manner as in Example 1, except that 50 wt % of the DMS-DPS oligomer diamine compound (Shin-etsu, X-22-1660B-3) was used based on the total monomer mass, and then a UTG multilayer structure coated with the polyimide film (thickness: 10 μm) was produced in the same manner as in Example 1.

### Reference Example 1

A polyimide precursor composition having a solid content of 25 wt % was prepared in the same manner as in Example 1, except that 25 wt % of the DMS-DPS oligomer diamine compound (Shin-etsu, X-22-1660B-3) was used based on the total monomer mass, and then a UTG multilayer structure coated with the polyimide film (thickness: 10 μm) was produced in the same manner as in Example 1.

### Comparative Example 1

An agitator with a nitrogen airflow flowing was filled with 213 g of DMPA. 30.9 g of TFMB was added thereto while the temperature of the reactor was maintained at 25° C. and was dissolved. 40 g of TMEG-100 was added thereto, and stirring was performed while it was dissolved at 50° C. for 6 hours and at room temperature for 24 hours, thereby preparing a polyamic acid resin. At this time, each monomer was at a mole ratio of TFMB:TMEG-100=0.99:1.0, and DMPA was further added to adjust the solid content to 20 wt %, thereby preparing the polyimide precursor composition of Comparative Example 1.

Next, the polyimide precursor composition was applied on an ultra-thin tempered glass (UTG, thickness: 30 μm) with a meyer bar, dried at 80° C. for 10 minutes under a nitrogen airflow, heated at 230° C. for 15 minutes, and cured to produce a UTG multilayer structure coated with the polyimide film (thickness: 10 μm).

### <Experimental Example 1> Analysis of Physical Properties

1-1. Measurement of Haze

In order to measure the transparency of the films produced in the examples, the reference example, and the comparative example, a haze (%) value was measured using a spectrophotometer (Nippon Denshoku, COH-5500) in accordance with the ASTM D1003 standard, and the results are shown in the following Table 3.

1-2. Measurement of Curls

A degree of curling from the ground was measured using a ruler at both ends of the UTG multilayer structures produced in the examples, the reference example, and the comparative example, and a curling amount (mm) was calculated as an average value of the values measured at both sides and the results are shown in the following Table 3.

TABLE 3

| | DMS-DPS oligomer | | | |
|---|---|---|---|---|
| | diamine compound | | Haze | Curl |
| | content | | (%) | (mm) |
| Example 1 | 40 | wt % | 0.12 | 0.95 |
| Example 2 | 45 | wt % | 0.11 | 0.78 |
| Example 3 | 50 | wt % | 0.11 | 0.25 |
| Reference | 25 | wt % | 0.12 | 2.56 |
| Example 1 | | | | |

| | | | |
|---|---|---|---|
| Comparative | — | 0.23 | 7.95 |
| Example 1 | | | |

Referring to Table 3, the polyimide film produced using the polyimide precursor composition according to one embodiment had excellent transparency and when a substrate was coated with the polyimide film, curling was significantly decreased.

### <Experimental Example 2> Thermal Gravimetric Analysis (TGA)

A temperature at which a weight was decreased by 1% as compared with an initial weight (Td, 1%) and a weight reduction rate at 600° C. depending on the content of DMS-DPS oligomer diamine were confirmed from the thermal gravimetric analysis of the polyimide films of the examples, the reference example, and the comparative example, and the results are shown in the following Table 4.

TABLE 4

| | Exam- | Exam- | Exam- | Reference | Comparative |
|---|---|---|---|---|---|
| | ple 1 | ple 2 | ple 3 | Example 1 | Example 1 |
| Td, 1% (° C.) | 355 | 353 | 351 | 374 | 395 |
| Weight | 72.3 | 74.2 | 77.2 | 67.6 | 49.2 |
| reduction | | | | | |
| rate | | | | | |
| (600° C., %) | | | | | |

Referring to Table 4, the polyimide film including the structure of Chemical Formula 1 had the temperature at which a weight was decreased by 1% as compared with an initial weight of 390° C. or lower or 380° C. or lower. In addition, the weight reduction rate at 600° C. was 60% or more or 65% or more.

In addition, referring to Table 4, the content of the unit derived from the acid anhydride or the diamine including the structure of Chemical Formula 1 in the polyimide film was able to be confirmed from the temperature at which a weight was decreased by 1% as compared with an initial weight (Td, 1%) and the weight reduction rate at 600° C. In Examples 1 to 3 and Reference Example 1 produced using the polyimide precursor composition including 20 wt % or more of the unit derived from the acid anhydride or the diamine including the structure of Chemical Formula 1 with respect to the total weight of the polyimide precursor, the temperature at which a weight was decreased by 1% as compared with an initial weight was 390° C. or lower or 380° C. or lower, and the weight reduction rate at 600° C. was 60% or more or 65% or more.

In addition, in Examples 1 to 3 produced using the polyimide precursor composition including 30 wt % or more of the unit derived from the acid anhydride or the diamine including the structure of Chemical Formula 1 with respect to the total weight of the polyimide precursor, the temperature at which a weight was decreased by 1% as compared with an initial weight was 370° C. or lower, and the weight reduction rate at 600° C. was 68% or more.

In summary, it was confirmed that the films according to Examples 1 to 3 and Reference Example 1 included the unit derived from the acid anhydride or the diamine including the structure of Chemical Formula 1, thereby having the temperature at which a weight was decreased by 1% as compared with an initial weight (Td, 1%) of 390° C. or lower, the weight reduction rate at 600° C. of 60% or more, and the haze measured in accordance with ASTM D1003 standard of 0.2% or less, and the UTG multilayer structure produced using the polyimide films had excellent optical properties and a curling amount of 4.0 mm or less or 3.5 mm or less.

In addition, it was confirmed in Examples 1 to 3 that the polyimide film was produced with the polyimide precursor composition which included 30 wt % or more of the unit derived from the acid anhydride or the diamine including the structure of Chemical Formula 1 with respect to the total weight of the polyimide precursor, and a solvent having a negative partition coefficient (log P), thereby having the temperature at which a weight was decreased by 1% as compared with an initial weight (Td, 1%) of 370° C. or lower, the weight reduction rate at 600° C. of 68% or more, and the haze measured in accordance with ASTM D1003 standard of 0.2% or less, and the UTG multilayer structure produced using the polyimide films had excellent optical properties and a curling amount of 2.5 mm or less.

### Example 4

An agitator with a nitrogen airflow flowing was filled with 230 g of a mixed solvent of propylene glycol methyl ether (PGME)/cyclohexanone (CHN) at a mass ratio of 8:2. In a state of maintaining the temperature of the reactor at 25° C., 29.0 g of 2,2′-bis(trifluoromethyl)benzidine (TFMB) and 29.6 g of a dimethylsiloxane-diphenylsiloxane (DMS-DPS) oligomer diamine compound (Shin-etsu, X-22-1660B-3, molecular weight: 4,400 g/mol) were added thereto and dissolved. 40 g of ethylene glycol bis(4-trimellitic anhydride (TMEG-100) was added thereto and stirring was performed while it was dissolved at 50° C. for 8 hours and at room temperature for 24 hours, thereby preparing a polyamic acid resin. At this time, each monomer had a mole ratio of TFMB/X-22-1660B-3:TMEG-100=0.99:1.0. A solvent in which PGME/CHN was mixed at a mass ratio of 8:2 was further added to adjust the solid content to 25 wt %, thereby preparing the polyimide precursor composition of Example 4.

Next, the polyimide precursor composition was applied on an ultra-thin tempered glass (UTG, thickness: 30 μm) with a meyer bar, dried at 80° C. for 10 minutes under a nitrogen airflow, heated at 230° C. for 15 minutes, and cured to produce a UTG multilayer structure coated with the polyimide film (thickness: 10 μm).

### Examples 5 and 6

The polyimide precursor compositions of Examples 5 and 6 were prepared in the same manner as in Example 4, except that the mass ratio of the solvents was adjusted as in the following Table 5, and then the UTG multilayer structures coated with the polyimide films (thickness: 10 μm) were produced in the same manner as in Example 4.

### Example 7

An agitator with a nitrogen airflow flowing was filled with 230 g of PGME. 29.0 g of TFMB and 29.6 g of a DMS-DPS oligomer diamine were added thereto and dissolved while the temperature of the reactor was maintained at 25° C. 40 g of TMEG-100 was added thereto, and stirring was performed while it was dissolved at 50° C. for 8 hours and at room temperature for 24 hours, thereby preparing a polyamic acid resin. At this time, each monomer had a mole ratio of TFMB/X-22-1660B-3:TMEG-100=0.99:1.0. 20 wt % of CHN with respect to the total solvent ratio was added to adjust the solid content to 25 wt %, thereby preparing the polyimide precursor composition of Example 7,

Next, the polyimide precursor composition was applied on an ultra-thin tempered glass (UTG, thickness: 30 μm) with a meyer bar, dried at 80° C. for 10 minutes under a nitrogen airflow, heated at 230° C. for 15 minutes, and cured to produce a UTG multilayer structure coated with the polyimide film (thickness: 10 μm).

### Examples 8 and 9

The polyimide precursor compositions of Examples 8 and 9 were prepared in the same manner as in Example 7, except that the mass ratio of the solvents was adjusted as in the following Table 5, and then the UTG multilayer structures coated with the polyimide films (thickness: 10 μm) were produced in the same manner as in Example 7.

### Examples 10 and 11

The polyimide precursor compositions of Examples 10 and 11 were prepared in the same manner as in Example 4, except that the DMS-DPS oligomer diamine was added at 40 wt % and 50 wt %, respectively based on the total monomer, and then the UTG multilayer structures coated with the polyimide films (thickness: 10 μm) were produced in the same manner as in Example 4.

### Comparative Example 2

The polyimide precursor composition of Comparative Example 2 was prepared in the same manner as in Example 4, except that diethylacetamide (DEAc) was used as a solvent instead of PGME/CHN, and then the UTG multilayer structure coated with the polyimide film (thickness: 10 μm) was produced in the same manner as in Example 4.

### Comparative Example 3

The polyimide precursor composition of Comparative Example 3 was prepared in the same manner as in Example 4, except that N-methylpyrrolidone (NMP) was used as a solvent instead of PGME/CHN, and then the UTG multilayer structure coated with the polyimide film (thickness: 10 μm) was produced in the same manner as in Example 4.

### Experimental Example 3

1-1. Analysis of Solvent Transparency

The polyimide precursor compositions prepared in the examples and the comparative examples were observed with the naked eye, and a uniform solvent state with no cloudiness observed was evaluated as “X”, weak cloudiness observed was evaluated as “o”, strong cloudiness observed was evaluated as “(D”, and the results are shown in the following Table 5.

1-2. Measurement of Curls

A degree of curling from the ground was measured using a ruler at both ends of the UTG multilayer structures produced in the examples and the comparative examples, and a curling amount (mm) was calculated as an average value of the values measured at both sides and the results are shown in the following Table 5.

TABLE 5

| | Solvent | DMS-DPS | | |
|---|---|---|---|---|
| | (mass ratio) | oligomer | | |
| | (reaction | diamine | | Curl |
| | conditions) | content | Transparency | (mm) |
| Example 4 | PGME/CHN | 30 wt % | X | 0.8 |
| | (8:2) (1 step) | | | |
| Example 5 | PGME/CHN | 30 wt % | X | 0.8 |
| | (7:3) (1 step) | | | |
| Example 6 | PGME/CHN | 30 wt % | X | 0.7 |
| | (9:1) (1 step) | | | |
| Example 7 | PGME/CHN | 30 wt % | X | 0.5 |
| | (8:2) (2 step) | | | |
| Example 8 | PGME/CHN | 30 wt % | X | 0.7 |
| | (7:3) (2 step) | | | |
| Example 9 | PGME/CHN | 30 wt % | X | 0.6 |
| | (9:1) (2 step) | | | |
| Example 10 | PGME/CHN | 40 wt % | X | 0.2 |
| | (8:2) (1 step) | | | |
| Example 11 | PGME/CHN | 50 wt % | X | 0.1 |
| | (8:2) (1 step) | | | |
| Comparative | DEAc | 30 wt % | ⊚ | 1.3 |
| Example 2 | | | | |
| Comparative | NMP | 30 wt % | ◯ | 1.3 |
| Example 3 | | | | |

Referring to Table 5, the polyimide precursor composition according to one embodiment had no cloudiness observed and was in a uniform solution state, and when an ultra-thin tempered glass was coated with the polyimide film produced using the composition, curling was significantly decreased.

The present disclosure relates to a polyimide precursor composition comprising a polyimide precursor comprising a siloxane structure and a solvent(s) having a negative partition coefficient (log P), and the polyimide precursor composition according to some embodiments are used to alleviate thermal expansion-contraction behavior, thereby producing a polyimide film with minimal curling.

Hereinabove, though the present disclosure has been described in detail by the preferred examples and experimental examples, the scope of the present disclosure is not limited to specific examples, and should be construed by the appended claims. In addition, it should be understood by a person skilled in the art that many modifications and variations are possible without departing from the scope of the present disclosure.

What is claimed is:

1. A polyimide precursor composition comprising:
a polyimide precursor comprising a unit derived from an acid anhydride or a diamine comprising a structure of the following Chemical Formula 1, and
a solvent having a negative partition coefficient (log P): 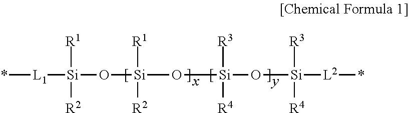
wherein
R¹ and R² are independently of each other C₁₋₅ alkyl which is unsubstituted or substituted with one or more halogens;
R³ and R⁴ are independently of each other C₄₋₁₀ aryl which is unsubstituted or substituted with one or more halogens;
L¹ and L² are independently of each other C₁₋₁₀ alkylene; and
x and y are independently of each other an integer of 1 or more.

2. The polyimide precursor composition of claim 1, wherein the structure of Chemical Formula 1 is a structure of the following Chemical Formula 2: 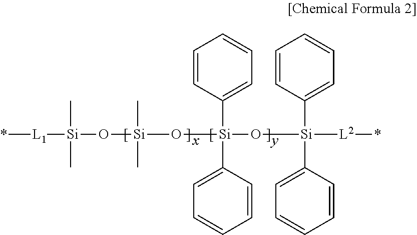
wherein
L¹ and L² are independently of each other C₁₋₁₀ alkylene; and
x and y are independently of each other an integer of 1 or more.

3. The polyimide precursor composition of claim 1, wherein the solvent having a negative partition coefficient comprises one or more solvents selected from propylene glycol methyl ether (PGME), dimethylformamide (DMF), dimethylacetamide (DMAc), N,N-dimethylpropaneamide (DMPA), N-ethylpyrrolidone (NEP), and/or methylpyrrolidone (NMP).

4. The polyimide precursor composition of claim 1, further comprising a solvent having a positive partition coefficient.

5. The polyimide precursor composition of claim 4, wherein the solvent having a positive partition coefficient comprises one or more solvents selected from cyclohexanone (CHN), N,N-diethylpropaneamide (DEPA), N,N-diethylacetamide (DEAc), and/or N,N-diethylformamide (DEF).

6. The polyimide precursor composition of claim 4, wherein the polyimide precursor composition comprises a mixed solvent of the solvent having a negative partition coefficient and the solvent having a positive partition coefficient, and the mixed solvent has a negative partition coefficient.

7. The polyimide precursor composition of claim 6, wherein the mixed solvent comprises a mixture of the solvent having a negative partition coefficient and the solvent having a positive partition coefficient at a mass ratio of 5:5 to 9.5:0.5.

8. The polyimide precursor composition of claim 1, wherein the unit derived from the acid anhydride or the diamine comprising the structure of Chemical Formula 1 is comprised at 20 wt % or more with respect to the total weight of the polyimide precursor.

9. The polyimide precursor composition of claim 1, wherein the acid anhydride or the diamine comprising the structure of Chemical Formula 1 has a molecular weight of 3000 g/mol or more.

10. A polyimide film comprising a cured product of the polyimide precursor composition of claim 1.

11. The polyimide film of claim 10,
wherein the film has a temperature at which a weight is decreased by 1% as compared with an initial weight is 390° C. or lower in thermal gravimetric analysis (TGA), and
a haze measured in accordance with the ASTM D1003 standard is 0.2% or less.

12. The polyimide film of claim 10, wherein a weight reduction rate at 600° C. is 60% or more in the thermal gravimetric analysis.

13. A method of preparing a polyimide precursor composition, the method comprising: reacting an acid anhydride or a diamine comprising a structure represented by the following Chemical Formula 1 with a solvent include comprising ing a solvent having a negative partition coefficient: 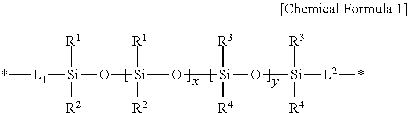
wherein
R¹ and R² are independently of each other C₁₋₅ alkyl which is unsubstituted or substituted with one or more halogens;
R³ and R⁴ are independently of each other C₄₋₁₀ aryl which is unsubstituted or substituted with one or more halogens;
L¹ and L² are independently of each other C₁₋₁₀ alkylene; and
x and y are independently of each other an integer of 1 or more.

14. The method of preparing a polyimide precursor composition of claim 13, wherein the solvent is a mixed solvent further comprising a solvent having a positive partition coefficient.

15. The method of preparing a polyimide precursor composition of claim 14, wherein the method comprises:
reacting a monomer comprising the acid anhydride or the diamine comprising the structure represented by Chemical Formula 1 in the presence of a mixed solvent of the solvent comprising a negative partition coefficient and the solvent comprising a positive partition coefficient to prepare a polyamic acid solution.

16. The method of preparing a polyimide precursor composition of claim 14, wherein the method comprises:
reacting a monomer comprising the acid anhydride or the diamine comprising the structure represented by Chemical Formula 1 in the presence of the solvent comprising a negative partition coefficient to prepare a polyamic acid solution; and
adding the solvent comprising a positive partition coefficient.

17. A flexible cover window comprising the polyimide film of claim 10.

18. A composition for coating ultra-thin tempered glass (ultra thin glass, UTG) comprising the polyimide precursor composition of claim 1.

19. An ultra-thin tempered glass multilayer structure coated with the composition for coating ultra-thin tempered glass of claim 18, on one or both surfaces of the ultra-thin tempered glass.

20. An ultra-thin tempered glass multilayer structure comprising the polyimide film of claim 10, on one or both surfaces of the ultra-thin tempered glass.
